(19) United States
(12) Patent Application Publication
(10) Pub. No.: US 2024/0154366 A1
(43) Pub. Date: May 9, 2024

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yusuke YAMADA, Mie (JP); Katsuhiko AIZAWA, Mie (JP); Kyohei IDA, Mie (JP)

(21) Appl. No.: 18/280,595

(22) PCT Filed: Mar. 1, 2022
(86) PCT No.: PCT/JP2022/008517

§ 371 Date: Sep. 6, 2023

(30) Foreign Application Priority Data
Mar. 8, 2021 (JP) 2021-036559

(51) Int. Cl. H01R 13/6581; H01R 13/502

(52) U.S. Cl. CPC H01R 13/6581; H01R 13/502

(57) ABSTRACT

Disclosed is a connector capable of improving heat dissipating performance while suppressing an increase in size. This connector 10 is provided with a housing 26 made of a synthetic resin and having a facing surface 28 facing a mounting target, a connection terminal 34 accommodated within the housing 26, an electric power conductor 32 connected to an end of a power line 30 and accommodated within the housing 26, and a shield shell 36 made of metal and covering the housing 26, wherein the shield shell 36 has an extending part 87 covering the facing surface 28 of the housing 26, the housing 26 has a first accommodating recess 52 accommodating a first fastening member 50 made of metal and fastening the connection terminal 34 and the electric power conductor 32, and a second accommodating recess 68 accommodating a second fastening member 66 made of metal and fastening the housing 26 and the extending part 87 of the shield shell 36, the first accommodating recess 52 and the second accommodating recess 68 being adjacent to each other with a shared resin wall 70 interposed therebetween.

### TECHNICAL FIELD

The present disclosure relates to a connector.

### BACKGROUND

Patent Document 1 discloses a connector provided with a housing made of synthetic resin, a current-carrying conductor connected to a connection terminal accommodated in the housing and an end of a wire and a shield shell made of metal for covering the housing. This connector is used, for example, by being mounted on a case of a device such as an inverter as a connector for relatively large current.

### PRIOR ART DOCUMENT

### Patent Document

Patent Document 1: JP 2020-161234 A

### SUMMARY OF THE INVENTION

### Problems to be Solved

In the connector shown in Patent Document 1, since the connection terminal and the current-carrying conductor are surrounded by the housing, heat generated by energization is not dissipated other than by being transferred to the wire via the current-carrying conductor. Thus, in response to a request for larger current, a heat generation amount needs to be reduced by increasing a conductor cross-sectional area and lowering an electric resistance value. In addition to the enlargement of the connection terminal and the current-carrying conductor, the enlargement of the wire is unavoidable. Thus, there has been an inherent problem of the enlargement of the entire connector.

Accordingly, a connector is disclosed which can improve heat dissipation performance while suppressing enlargement.

### Means to Solve the Problem

The present disclosure is directed to a connector with a housing made of synthetic resin, the housing having a facing surface facing a mounting object, a connection terminal accommodated in the housing, a current-carrying conductor connected to an end of a cable, the current-carrying conductor being accommodated in the housing, and a shield shell made of metal for covering the housing, the shield shell including an extending portion for covering the facing surface of the housing, the housing including a first accommodation recess for accommodating a first fastening member made of metal for fastening the connection terminal and the current-carrying conductor and a second accommodation recess for accommodating a second fastening member made of metal for fastening the housing and the extending portion of the shield shell, and the first accommodation recess and the second accommodation recess being adjacent across a common resin wall.

### Effect of the Invention

According to the connector of the present disclosure, it is possible to improve heat dissipation performance while suppressing enlargement.

### BRIEF DESCRIPTION OF THE DRAWINGS

FIG. 1 is a perspective view showing a state where a connector according to one embodiment is mounted on a case of a device.

FIG. 2 is a perspective view of the inside of the connector of FIG. 1 when viewed from above.

FIG. 3 is a perspective view of the connector of FIG. 1 when viewed laterally.

FIG. 4 is a bottom view of the connector shown in FIG. 1.

FIG. 5 is a perspective view of a housing in the connector of FIG. 1 when viewed obliquely from above.

FIG. 6 is a perspective view of the housing in the connector of FIG. 1 when viewed obliquely from below.

FIG. 7 is a plan view of the device shown in FIG. 1.

FIG. 8 is an enlarged section along VIII-VIII in FIG. 2.

FIG. 9 is an enlarged section along IX-IX in FIG. 1.

FIG. 10 is an enlarged section along X-X in FIG. 1.

### DETAILED DESCRIPTION TO EXECUTE THE INVENTION

### Description of Embodiments of Present Disclosure

First, embodiments of the present disclosure are listed and described.

(1) The connector of the present disclosure is provided with a housing made of synthetic resin, the housing having a facing surface facing a mounting object, a connection terminal accommodated in the housing, a current-carrying conductor connected to an end of a cable, the current-carrying conductor being accommodated in the housing, and a shield shell made of metal for covering the housing, the shield shell including an extending portion for covering the facing surface of the housing, the housing including a first accommodation recess for accommodating a first fastening member made of metal for fastening the connection terminal and the current-carrying conductor and a second accommodation recess for accommodating a second fastening member made of metal for fastening the housing and the extending portion of the shield shell, and the first accommodation recess and the second accommodation recess being adjacent across a common resin wall.

According to the connector of the present disclosure, the shield shell includes the extending portion for covering the facing surface of the housing facing the mounting object such as a case of a device, and the housing and the shield shell are fixed by fastening the extending portion and the housing by the second fastening member made of metal. In this way, the second fastening member made of metal for fastening the housing and the shield shell can be arranged close to the first fastening member made of metal for fastening the connection terminal and the current-carrying conductor. That is, the first accommodation recess for accommodating the first fastening member and the second accommodation recess for accommodating the second fastening member can be arranged adjacent across the common resin wall. In this way, heat generated in the connection terminal and the current-carrying conductor by energization can be transferred from the first fastening member to the second fastening member via the resin wall and dissipated to the shield shell. As a result, a new heat dissipation path via the first fastening member, the resin wall, the second fastening member and the shield shell is added in addition to a heat dissipation path to the cable as in conventional structures, and heat dissipation performance can be improved while the enlargement of the connector is suppressed. Note that bolts, nuts or the like can be used as the first and second fastening members.

(2) Preferably, the second accommodation recess is open in the facing surface of the housing, the first accommodation recess is open on a side opposite to the facing surface of the housing, and the first accommodation recess and the second accommodation recess at least partially overlap in projection in a direction intersecting a facing direction of the facing surface and the mounting object. Since the first accommodation recess and the second accommodation recess are respectively open in the facing surface of the housing and on the side opposite to the facing surface, insulation between the first and second fastening members can be advantageously ensured. In this way, the first and second accommodation recesses can be arranged to at least partially overlap in projection in the direction intersecting the facing direction of the facing surface and the mounting object, and heat transfer between the first and second fastening members can also be improved.

(3) Preferably, the resin wall separating the first accommodation recess and the second accommodation recess has a wall thickness of 2 mm or less. Since the wall thickness of the resin wall separating the first accommodation recess and the second accommodation recess is 2 mm or less, heat dissipation via the shield shell can be promoted by improving heat transfer from the first fastening member to the second fastening member via the resin wall. As a result, the heat dissipation performance of the connector can be more improved.

(4) Preferably, the shield shell includes a fixing portion for the mounting object made of metal. Since the shield shell includes the fixing portion for the mounting object made of metal such as a metal case of a device, a heat transfer path from the shield shell to the mounting object is constructed. As a result, the heat dissipation performance of the connector can be further improved by utilizing a wide surface area of the mounting object.

(5) Preferably, the cable is constituted by the shielded cable including a shield member, and the shield member is connected to the extending portion of the shield shell. The shield member of the shielded cable is connected to the extending portion of the shield shell for covering the facing surface of the housing. Therefore, a ground path of the shield member can be constructed via the shield shell fixed to the body-grounded mounting object. Particularly, since the ground path is constructed using the extending portion, the ground path of the shield member can be constructed by a small number of components.

### Details of Embodiment of Present Disclosure

A specific example of a connector of the present disclosure is described below with reference to the drawings. Note that the present disclosure is not limited to these illustrations, but is represented by claims and intended to include all changes in the scope of claims and in the meaning and scope of equivalents.

### Embodiment

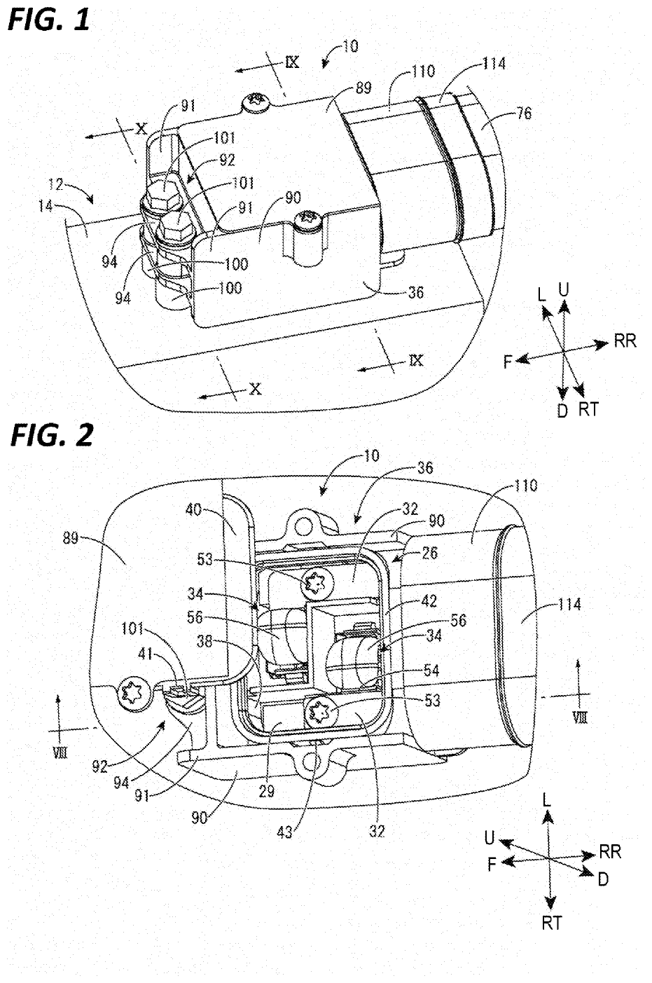

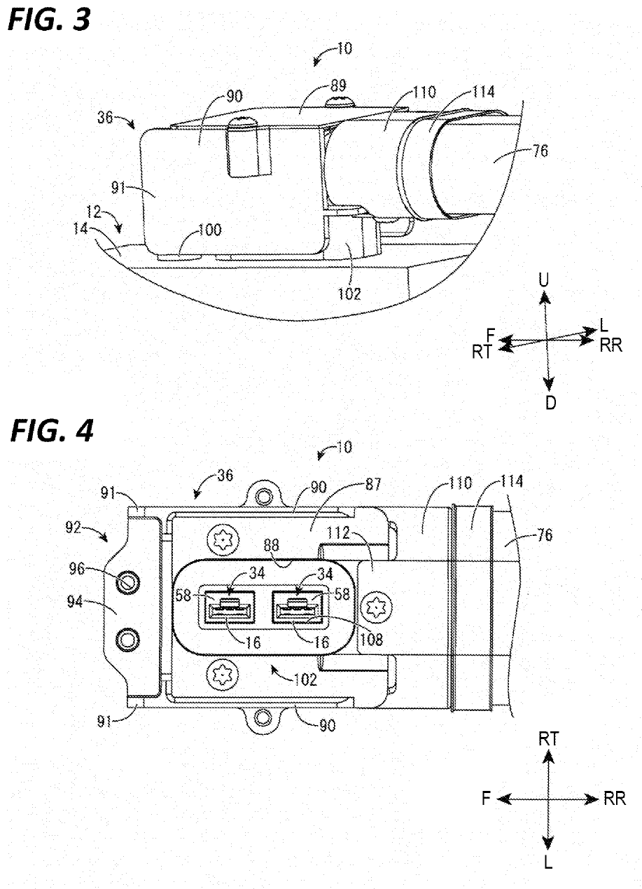

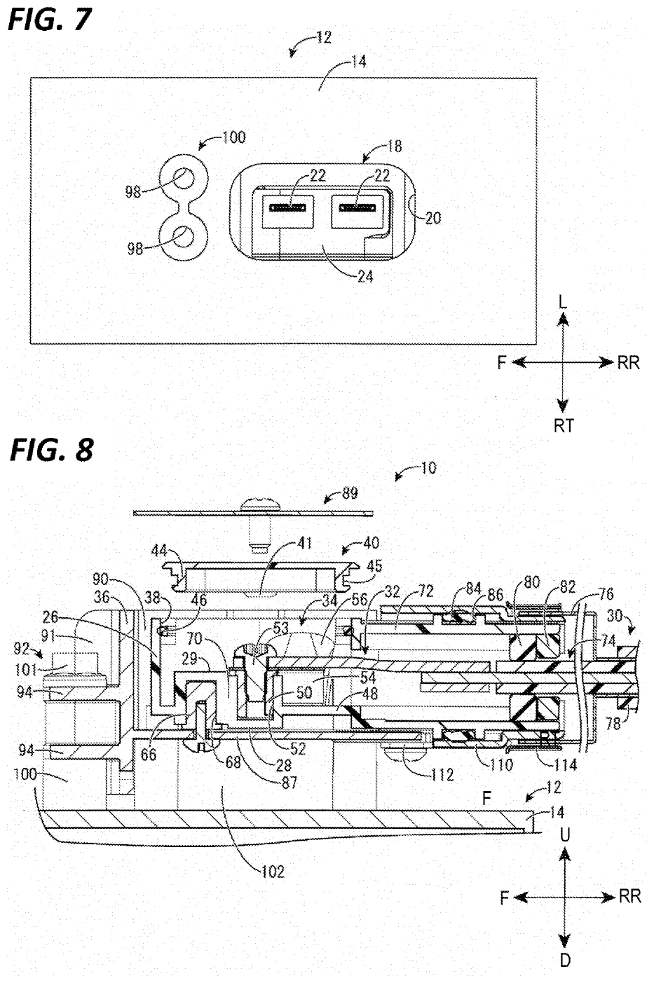

Hereinafter, a connector 10 of one embodiment of the present disclosure is described using FIGS. 1 to 10. For example, as shown in FIG. 1, the connector 10 is used by being mounted on a case 14 of a device 12 such as an inverter as a mounting object. More particularly, as shown in FIG. 4, a pair of female terminals 16, 16 (constituting connection terminals 34 to be described later) are provided to project downward on the bottom surface of the connector 10. On the other hand, as shown in FIG. 7, a device-side connector 18 is provided in the case 14 of the device 12 and a pair of male terminals 22, 22 provided in the device-side connector 18 are provided to project upward through insertion holes 20 penetrating through the case 14. By mounting the connector 10 on the case 14 of the device 12, the female terminals 16 of the connector 10 and the male terminals 22 of the device 12 are connected. Note that the connector 10 can be arranged in an arbitrary orientation, but a vertical direction, a lateral direction and a front-rear direction are based on a vertical direction, a lateral direction and a front-rear direction shown in figures in the following description. Further, for a plurality of identical members, only some members may be denoted by a reference sign and the other members may not be denoted by the reference sign.

<Device-Side Connector 18>

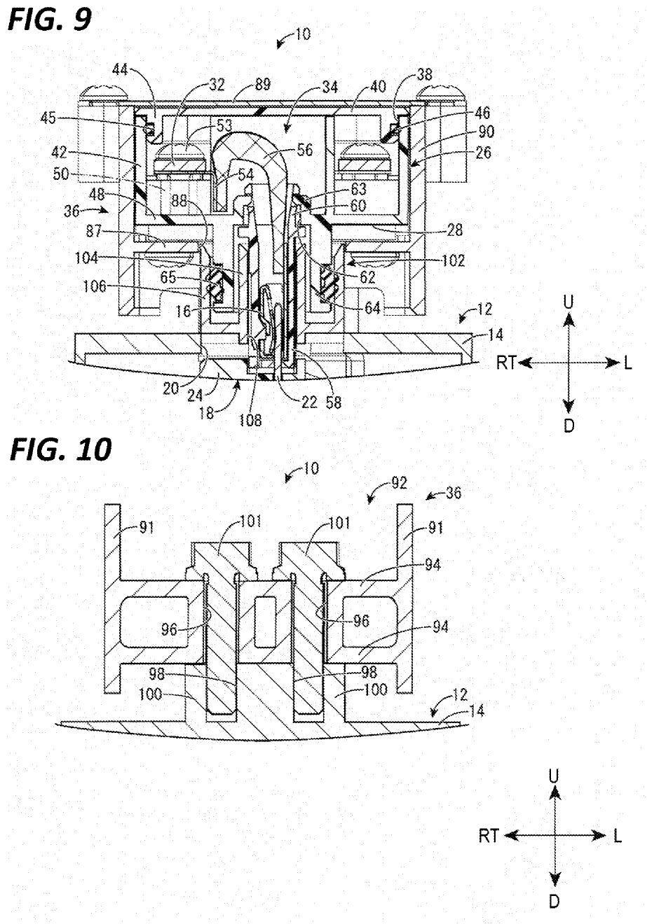

As shown in FIGS. 7 and 9, the device-side connector 18 includes the pair of male terminals 22, 22 and a device-side housing 24 for accommodating the pair of male terminals 22, 22, the device-side housing 24 being fixed in the case 14 of the device 12.

<Connector 10>

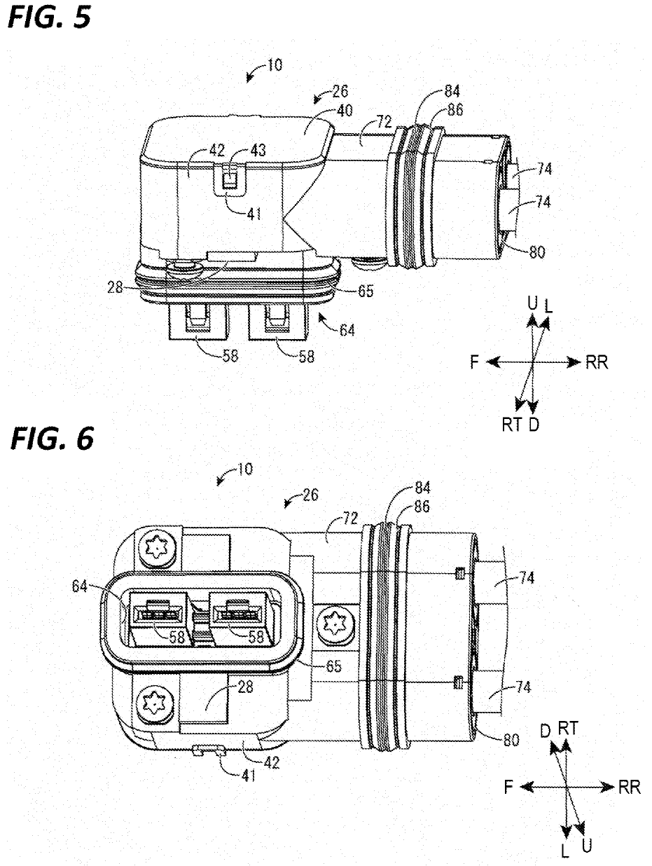

The connector 10 is provided with a housing 26 made of synthetic resin. As shown in FIGS. 5, 6 and 8, the housing 26 has a facing surface 28 facing the case 14 of the device 12 as the mounting object when the connector 10 is mounted on the case 14 of the device 12. Current-carrying conductors 32 connected to an end of a shielded cable 30 constituting a cable are accommodated in the housing 26. Further, as shown in FIG. 9, the connection terminals 34 are accommodated in the housing 26. The connection terminals 34 are arranged on the side of the facing surface 28 of the housing 26. The connection terminals 34 are fit and connected to the male terminals 22 of the device-side connector 18 when the connector 10 is mounted on the case 14 of the device 12. The current-carrying conductors 32 and the connection terminals 34 are connected in the housing 26 as described later. Further, the connector 10 is provided with a shield shell 36 made of metal for covering a front side of the housing 26.

<Housing 26>

As shown in FIGS. 5 and 6, the housing 26 is formed to have a substantially rectangular shape long in the front-rear direction. A rear side of the housing 26 is covered by a shield bracket 110 as described later, and the front side of the housing 26 is covered by the shield shell 36 made of metal. The front side of the housing 26 is formed into a box shape and includes an upper opening 38 open upward. As shown in FIGS. 2 and 8, the upper opening 38 is covered by a lid body 40 in the form of a rectangular flat plate. The lid body 40 is provided with engaged frame bodies 41 projecting downward from peripheral edge parts facing each other in the lateral direction. The engaged frame bodies 41 and projections 43 projecting on outer peripheral surfaces facing each other in the lateral direction of a peripheral wall 42 in the form of a rectangular tube constituting the upper opening 38 are engaged, whereby the lid body 40 is fixed to the peripheral wall 42 of the housing 26. Further, an annular hanging wall portion 44 hanging down from the bottom surface of the lid body 40 is formed inside the engaged frame bodies 41 of the lid body 40. An annular sealing member accommodation groove 45 is formed in the outer peripheral surface of the hanging wall portion 44. By accommodating a sealing member 46 into the sealing member accommodation groove 45, the upper opening 38 of the housing 26 is sealed by the lid body 40.

As shown in FIG. 8, which is a section along VIII-VIII of FIG. 2, a bottom wall 48 on the front side of the housing 26 includes first accommodation recesses 52 for accommodating nuts 50 serving as first fastening members made of metal for fastening the connection terminals 34 and the current-carrying conductors 32. The first accommodation recesses 52 are open in a surface 29 of the housing 26 opposite to the facing surface 28. As shown in FIGS. 8 and 9, the current-carrying conductor 32 is connected to a coupling fitting 54 in the form of a flat plate bent into an L shape by tightening a bolt 53 into the nut 50 serving as the first fastening member accommodated in the first accommodation recess 52. The coupling fitting 54 is connected to the female terminal 16 via a flexible conductor 56 bent into an inverted U shape. The coupling fitting 54 and the flexible conductor 56 of the female terminal 16 are joined by a known technique such as welding. The flexible conductor 56 is a braided member formed by braiding a plurality of metal wires and, for example, braided into a tubular shape. The connection terminal 34 is constituted by the coupling fitting 54, the flexible conductor 56 and the female terminal 16.

The female terminal 16 is used by being accommodated in a female terminal accommodating portion 58 provided in the housing 26. More particularly, as shown in FIG. 9, the female terminal accommodating portion 58 is provided to project downward in a substantially central part of the bottom wall 48 of the housing 26. The female terminal accommodating portion 58 has a tubular shape open in the vertical direction and is provided with a pair of engaged frame bodies 60, 60 on an upper side. A female terminal accommodating portion insertion hole 62, into which the female terminal accommodating portion 58 is inserted, is provided to penetrate through the bottom wall 48 of the housing 26, and a pair of engaging protrusions 63, 63 are provided to project on a peripheral edge part of the female terminal accommodating portion insertion hole 62. The pair of engaged frame bodies 60, 60 and the pair of engaging protrusions 63, 63 are respectively engaged, whereby the female terminal accommodating portion 58 accommodating the female terminal 16 is fixed to the bottom wall 48 of the housing 26. A tubular receptacle 64 is provided to project downward on a peripheral edge part of a lower surface side of the female terminal accommodating portion insertion hole 62. A sealing member 65 made of rubber is mounted on the outer peripheral surface of the receptacle 64.

As shown in FIG. 8, a second accommodation recess 68 for accommodating a nut 66 serving as a second fastening member made of metal is formed in front of the first accommodation recesses 52 to fasten an extending portion 87 of the shield shell 36 to be described later to the bottom wall 48 of the housing 26. The second accommodation recess 68 is open in the facing surface 28 of the housing 26. As is clear from FIG. 8, the first and second accommodation recesses 52, 68 substantially perfectly overlap in projection in a direction (front-rear direction) intersecting a facing direction (vertical direction) of the facing surface 28 and the case 14 of the device 12 serving as the mounting object. Further, the first and second accommodation recesses 52, 68 are adjacent to each other across an insulating common resin wall. In this embodiment, a wall thickness of the resin wall 70 separating the first and second accommodation recesses 52, 68 is 2 mm or less. In this way, heat transfer between the nuts 50 accommodated in the first accommodation recesses 52 and the nut 66 accommodated in the second accommodation recess 68 via the resin wall 70 can be improved. Therefore, heat dissipation from the nut 66 via the shield shell 36 can be promoted and the heat dissipation performance of the connector 10 can be more improved.

As shown in FIG. 8, a tubular portion 72 in the form of a rectangular tube, extending rearward and open in the front-rear direction is provided on the rear side of the housing 26. An end part of the shielded cable 30 and the current-carrying conductors 32 connected to the end part of the shielded cable 30 are accommodated in the tubular portion 72. The shielded cable 30 extends rearward from a rear end part of the tubular portion 72. The shielded cable 30 constituting a cable is configured such that coated wires 74 are covered by a braided wire 76 serving as a shield member and made of metal wires and the braided wire 76 is further covered by an insulation coating 78. The insulation coating 78 of the shielded cable 30 is stripped to expose the braided wire 76 on a rear side of the tubular portion 72, and the coated wires 74 are routed in the tubular portion 72. A sealing member 80 made of rubber for sealing the coated wires 74 and a retainer 82 for holding the sealing member 80 at a predetermined position are mounted in a rear end part of the tubular portion 72. As described later, the braided wire 76 is connected to the shield bracket 110 overlapped on the outer peripheral surface of the tubular portion 72. A sealing member accommodating portion 86 for accommodating a sealing member 84 made of rubber and sealing between the shield bracket 110 to be described later and the outer peripheral surface of the tubular portion 72 is provided in the outer peripheral surface of the tubular portion 72.

<Shield Shell 36>

As shown in FIGS. 8 and 9, the shield shell 36 is arranged to cover the front side of the housing 26. The shield shell 36 includes the extending portion 87 for covering the facing surface 28 of the housing 26. An intermediate shield member accommodation hole 88 for accommodating an intermediate shield member 102 to be described later is provided to penetrate through the extending portion 87 (see FIGS. 4 and 9). The shield shell 36 has a rectangular box shape and is open upward and rearward. As shown in FIG. 1 and the like, an upper side of the shield shell 36 is covered by bolting a lid portion 89 made of metal and in the form of a rectangular flat plate. As shown in FIG. 1, a pair of side walls 90, 90 of the shield shell 36 facing each other in the lateral direction extend forward, and a fixing portion 92 is provided between a pair of extending walls 91, 91. As shown in FIG. 10, the fixing portion 92 is provided with a pair of bolt insertion holes 96, 96 separated in the lateral direction in a pair of fixing walls 94, 94 formed apart from each other in the vertical direction. Further, as shown in FIG. 7, a pair of bosses 100, 100 each having a bottomed hollow cylindrical shape and including a bolt insertion hole 98 in a center are provided to project upward on the case 14 of the device 12. By fixing the fixing portion 92 to the bosses 100 by tightening bolts 101 after the bolt insertion holes 96 are aligned with the bolt insertion holes 98, the connector 10 is fixed to the case 14 of the device 12. As a result, as shown in FIG. 10, the shield shell 36 is connected to the case 14 of the device 12 at the fixing portion 92.

As shown in FIG. 9, the pair of side walls 90, 90 of the shield shell 36 facing each other in the lateral direction extend downward from the extending portion 87 by such a dimension as not to come into contact with the case 14 when the connector 10 is mounted on the case 14 of the device 12. When the connector 10 is mounted on the case 14 of the device 12, the intermediate shield member 102 made of metal is held with an upper end part accommodated in the intermediate shield member accommodation hole 88 between the extending portion 87 and the case 14. The intermediate shield member 102 has a bottomed rectangular tube shape including an inner wall 104 and an outer wall 106. As shown in FIG. 9, a wall portion constituting the receptacle 64 is inserted between the inner wall 104 and the outer wall 106, and a space between the inner surface of the outer wall 106 and the wall portion constituting the receptacle 64 is sealed by the sealing member 65. Female terminal housing through holes 108, into which the female terminal accommodating portions 58 are inserted and arranged, are provided to penetrate inside the inner wall 104.

<Shield Bracket 110>

As shown in FIG. 8, the shield bracket 110 is arranged to cover the outer peripheral surface of the tubular portion 72 of the housing 26. A space between the shield bracket 110 and the outer peripheral surface of the tubular portion 72 of the housing 26 is sealed by the sealing member 84. As shown in FIGS. 4 and 8, the shield bracket 110 includes a rectangular projecting portion 112 projecting forward on the bottom surface side. In this projecting portion 112, the shield bracket 110 is screwed and connected to the shield shell 36. Further, a rear side of the shield bracket 110 has smaller dimensions than the front side. In this part having smaller dimensions, the shield bracket 110 and the braided wire 76 serving as the shield member of the shielded cable 30 are pressed radially inward and fixed by a pressing ring 114 made of metal. In this way, the shield bracket 110 and the braided wire 76 are connected. As a result of the above, the braided wire 76 serving as the shield member is connected to the extending portion 87 of the shield shell 36. Moreover, as described above, the shield shell 36 is connected to the case 14 of the device 12 at the fixing portion 92.

<Assembling Method of Connector 10>

As shown in FIG. 9, the device-side connector 18 is first prepared in which the male terminals 22 are accommodated and held in the device-side housing 24 while extending in the vertical direction. An unillustrated fixing portion of the device-side connector 18 is fixed to the case 14 of the device 12 by bolting. Subsequently, as shown in FIGS. 5 and 6, the housing 26 is prepared. The female terminal accommodating portions 58 are removed from the housing 26 in advance. After being mounted into this housing 26, the shield shell 36 is bolted to the second accommodation recess 68, whereby the extending portion 87 of the shield shell 36 is connected to the nut 66 accommodated in the second accommodation recess 68 of the housing 26. In this way, the shield shell 36 is fixed to the housing 26. Then, the female terminals 16 each having the flexible conductor 56 and the coupling fitting 54 connected thereto are accommodated into the female terminal accommodating portions 58. Subsequently, the female terminal accommodating portions 58 are accommodated into the receptacle 64 and the engaged frame bodies 60 of the female terminal accommodating portions 58 are engaged with the engaging protrusions 63 projecting on the bottom wall 48 of the housing 26, whereby the female terminal accommodating portions 58 are fixed at predetermined positions. Subsequently, after the current-carrying conductors 32 connected to the shielded cable 30 are inserted into the housing 26 from behind, tip parts of the current-carrying conductors 32 are placed on the first accommodation recesses 52 on which the coupling fittings 54 are placed. Here, in the rear end part of the shield bracket 110 having smaller dimensions, the shield bracket 110 and the braided wire 76 serving as the shield member of the shielded cable 30 are fixed and connected by the pressing ring 114. In this way, the shield bracket 110 and the braided wire 76 are connected. After the shield bracket 110 is arranged to cover the outer peripheral surface of the tubular portion 72 of the housing 26, the shield bracket 110 is connected and fixed to the extending portion 87 of the shield shell 36 by bolting at the projecting portion 112 of the shield bracket 110. In this way, the braided wire 76 serving as the shield member is connected to the extending portion 87 of the shield shell 36.

Thereafter, the coupling fittings 54 are placed on the first accommodation recesses 52 by bending the flexible conductors 56. Subsequently, the coupling fittings 54 are fixed and connected to the nuts 50 serving as the first fastening members together with the current-carrying conductors 32 by bolting. Then, after the upper opening 38 of the housing 26 is covered by the lid body 40, an upper part of the lid body 40 is covered using the lid portion 89 and the lid portion 89 is fixed to an upper part of the shield shell 36 by bolting. In this way, the connector 10 is completed.

Finally, the connector 10 configured as just described is fixed to the case 14 by bolting the fixing portion 92 to the bosses 100 provided on the case 14 of the device 12, whereby a ground path is formed. That is, the braided wire 76 serving as the shield member of the shielded cable 30, the shield bracket 110 and the shield shell 36 are connected, and the shield shell 36 is connected to the case 14 of the device 12 via the fixing portion 92, whereby the ground path is completed. Further, by mounting the connector 10 on the case 14 of the device 12, the female terminals 16 of the connector 10 are connected to the male terminals 22 of the device 12. In mounting the connector 10 on the case 14 of the device 12, the intermediate shield member 102 is arranged in the intermediate shield member accommodation hole 88 in advance. As a result of the above, the assembling of the connector 10 is completed.

According to the connector 10 of the present disclosure thus structured, the shield shell 36 includes the extending portion 87 for covering the facing surface 28 of the housing 26 facing the case 14 of the device 12 serving as the mounting object. The bottom wall 48 of the housing 26 and the extending portion 87 of the shield shell 36 are fixed by being fastened using the nut 66 serving as the second fastening member made of metal. In this way, the nut 66 for fastening the housing 26 and the shield shell 36 can be arranged close to the nuts 50 serving as the first fastening members for fastening the connection terminals 34 arranged on the side of the facing surface 28 of the housing 26 and the current-carrying conductors 32 connected to the end of the shielded cable 30. That is, the first accommodation recesses 52 for accommodating the nuts 50 and the second accommodation recess 68 for accommodating the nut 66 can be arranged adjacent across the common resin wall 70. Therefore, heat generated by the connection terminals 34 and the current-carrying conductors 32 by energization can be transferred from the nuts 50 to the nut 66 via the resin wall 70 and dissipated to the shield shell 36. In this way, a new heat dissipation path via the nuts 50, the resin wall 70, the nut 66 and the shield shell 36 is added in addition to a conventional heat dissipation path through the wires, wherefore heat dissipation performance can be improved while the enlargement of the connector 10 is suppressed.

Further, since the first and second accommodation recesses 52, 68 are respectively open in the facing surface 28 of the housing 26 and the surface 29 of the housing 26 opposite to the facing surface 28, insulation between the first fastening members (nuts 50) and the second fastening member (nut 66) can be advantageously ensured. Moreover, the first fastening members (nuts 50) and the second fastening member (nut 66) substantially perfectly overlap in projection in the direction (front-rear direction) intersecting the facing direction of the facing surface 28 and the case 14 of the device 12 serving as the mounting object. Therefore, heat transfer between the first fastening members (nuts 50) and the second fastening member (nut 66) can also be improved. In addition, the shield shell 36 includes the fixing portion 92 for the case 14 of the device 12 serving as the mounting object. Since a heat transfer path from the shield shell 36 to the case 14 of the device 12 is constructed in this way, the heat dissipation performance of the connector 10 can be further improved by utilizing a wide surface area of the case 14 of the device 12.

Further, the braided wire 76 serving as the shield member of the shielded cable 30 is connected to the extending portion 87 of the shield shell 36 for covering the facing surface 28 of the housing 26. Thus, a ground path of the braided wire 76 serving as the shield member can be constructed via the shield shell 36 fixed to the case 14 of the device 12 serving as the body-grounded mounting object. Particularly, since the ground path is constructed by using the extending portion 87 of the shield shell 36, the ground path of the braided wire 76 serving as the shield member can be constructed by a small number of components.

<Modifications>

Although the embodiment has been described in detail as a specific example of the present disclosure above, the present disclosure is not limited by this specific description. The present disclosure includes modifications, improvements and the like within a range in which the aim of the present disclosure can be accomplished. For example, the following modifications of the embodiment are also included in the technical scope of the present disclosure.

(1) Although the case 14 of the device 12 such as an inverter has been illustrated and described as the mounting object in the above embodiment, there is no limitation to this. The mounting object may be a case 14 of any device 12 or a connector or terminal block if it is provided with mating terminals to be connected to the connection terminals 34.

(2) Although the nuts 50, 66 have been illustrated as the first and second fastening members in the above embodiment, there is no limitation to this. Bolts accommodated in the first and second accommodation recesses 52, 58 may be used as the first and second fastening members.

(3) Although the first fastening members (nuts 50) and the second fastening members (nut 66) substantially perfectly overlap in projection in the direction (front-rear direction) intersecting the facing direction of the facing surface 28 and the case 14 of the device 12 serving as the mounting object in the above embodiment, there is no limitation to this. The first fastening members (nuts 50) and the second fastening members (nut 66) may or may not overlap in projection in the direction (front-rear direction) intersecting the facing direction of the case 14 of the device 12.

### LIST OF REFERENCE NUMERALS

10 connector (embodiment)
12 device
14 case (mounting object)
16 female terminal
18 device-side connector
20 insertion hole
22 male terminal
24 device-side housing
26 housing
28 facing surface
29 surface on opposite side
30 shielded cable (cable)
32 current-carrying conductor
34 connection terminal
36 shield shell
38 upper opening
40 lid body
41 engaged frame body
42 peripheral wall
43 projection
44 hanging wall portion
45 sealing member accommodation groove
46 sealing member
48 bottom wall
50 nut (first fastening member)
52 first accommodation recess
53 bolt
54 coupling fitting
56 flexible conductor
58 female terminal accommodating portion
60 engaged frame body
62 female terminal accommodating portion insertion hole
63 engaging protrusion
64 receptacle
65 sealing member
66 nut (second fastening member)
68 second accommodation recess
70 resin wall
72 tubular portion
74 coated wire
76 braided wire (shield member)
78 insulation coating
80 sealing member
82 retainer
84 sealing member
86 sealing member accommodating portion
87 extending portion
88 intermediate shield member accommodation hole
89 lid portion
90 side wall
91 extending wall
92 fixing portion
94 fixing wall
96 bolt insertion hole
98 bolt insertion hole
100 boss
101 bolt
102 intermediate shield member
104 inner wall
106 outer wall
108 female terminal housing through hole
110 shield bracket
112 projecting portion
114 pressing ring

1. A connector, comprising:
a housing made of synthetic resin, the housing having a facing surface facing a mounting object;
a connection terminal accommodated in the housing,
a current-carrying conductor connected to an end of a cable, the current-carrying conductor being accommodated in the housing; and
a shield shell made of metal for covering the housing,
the shield shell including an extending portion for covering the facing surface of the housing,
the housing including a first accommodation recess for accommodating a first fastening member made of metal for fastening the connection terminal and the current-carrying conductor and a second accommodation recess for accommodating a second fastening member made of metal for fastening the housing and the extending portion of the shield shell, and
the first accommodation recess and the second accommodation recess being adjacent across a common resin wall.

2. The connector of claim 1, wherein:
the second accommodation recess is open in the facing surface of the housing,
the first accommodation recess is open on a side opposite to the facing surface of the housing, and
the first accommodation recess and the second accommodation recess at least partially overlap in projection in a direction intersecting a facing direction of the facing surface and the mounting object.

3. The connector of claim 1, wherein the resin wall separating the first accommodation recess and the second accommodation recess has a wall thickness of 2 mm or less.

4. The connector of claim 1, wherein the shield shell includes a fixing portion for the mounting object made of metal.

5. The connector of claim 4, wherein:
the cable is constituted by the shielded cable including a shield member, and
the shield member is connected to the extending portion of the shield shell.
